(19) United States
(12) Patent Application Publication
(10) Pub. No.: US 2025/0225853 A1
(43) Pub. Date: Jul. 10, 2025

(54) ANTI-FRAUD AND SURFACE ACOUSTIC SYSTEM

(71) Applicant: TOSHIBA GLOBAL COMMERCE SOLUTIONS, INC., Durham, NC (US)

(72) Inventors: Chih-Huang WANG, Taipei City (TW); Yi-Sheng LEE, Taipei City (TW); Wei-Yi HSUAN, Taipei City (TW); Te-Chia TSAI, Taipei City (TW)

(21) Appl. No.: 18/409,609

(22) Filed: Jan. 10, 2024

(51) Int. Cl. G08B 13/24; G01S 15/08; G01S 15/89; G07G 3/00

(52) U.S. Cl. CPC G08B 13/246; G01S 15/08; G07G 3/003; G01S 15/89

(57) ABSTRACT

Method and apparatus for fraud detection are provided. Sensor data from one or more acoustic wave sensors is received, where the one or more acoustic wave sensors transmit acoustic waves towards a set of items within a receptacle and receive reflected acoustic waves from the set of items. A model for the set of items within the receptacle is generated based on the sensor data. One or more features for the set of items are identified by analyzing the model. Checkout data is retrieved from one or more checkout devices. The one or more features for the set of items identified from the model are compared with the checkout data. An alert is generated upon detecting a discrepancy between the one or more features and the checkout data.

### BACKGROUND

Acoustic wave sensors can be used to detect and analyze a variety of physical properties of objects across a wide range of applications. These sensors operate by emitting acoustic waves and then analyzing the returning signals from nearby objects. Through this process, the sizes and shapes of nearby objects can be effectively mapped, providing valuable information about the surrounding environment. Additionally, by emitting and collecting acoustic waves, the acoustic wave sensors can further provide depth-related information, such as time of flight that can be used to measure the distance of an object from the sensors. This feature is useful in scenarios where understanding spatial relationships is important in determining the location and number of objects within a given space. The accuracy and reliability of acoustic wave sensors in capturing and analyzing acoustic signals, coupled with their ability to provide a wide range of property information, have led to the widespread use of these sensors in environmental detection and object identification.

### BRIEF DESCRIPTION OF THE DRAWINGS

FIG. 1 depicts an example environment for advanced fraud detection using acoustic technology, according to some embodiments of the present disclosure.

FIG. 2 depicts travel paths for acoustic waves induced by acoustic wave sensors installed at different locations around a receptacle, according to some embodiments of the present disclosure.

FIG. 3 depicts an example workflow for detecting checkout fraud using sensor data, according to some embodiments of the present disclosure.

FIG. 4 depicts an example method for generating alerts in response to potential checkout fraud based on collected sensor data and checkout data, according to some embodiments of the present disclosure.

FIG. 5 is a flow diagram depicting an example method for fraud detection, according to some embodiments of the present disclosure.

FIG. 6 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without recitation.

### DETAILED DESCRIPTION

In some embodiments of the present disclosure, a scanning area is established near the self-checkout queues at an enterprise site (e.g., a retail establishment). Within the scanning area, one or more acoustic wave sensors are installed to capture the contents of carts or other receptacles (e.g., baskets, bags) as waiting customers move through the area. In some instances, a “receptacle” may refer to any container (which may be open on one or more sides or may be entirely enclosed) that is capable of carrying or containing items. This includes, but not limited to, carts, baskets, and bags. Additionally, in situations where items are simply being carried in the user's hands or arms, the user herself may be considered as the receptacle. These sensors may be placed at different locations within the scanning area, to capture the receptacle's contents from different angles. The sensors operate by emitting acoustic waves towards the receptacle, then receiving the signals that are reflected, distorted, or otherwise altered by the receptacle or the items within. In some embodiments, these received signals may then be aggregated and analyzed to generate a model (e.g., a 3D representation) that depicts the receptacle's contents. In some embodiments, the model may detail the physical dimensions, shapes, and arrangements of the items within the receptacle.

In some embodiments of the present disclosure, the model created based on the sensor data may be further analyzed to identify various characteristics or features of the items within the receptacle. The analysis may include determining the overall quantity of items within the receptacle, as well as the shape, size, location, material, or other relevant features of each item. In some embodiments, after extracting these features, more advanced analysis, such as object recognition, may be conducted using trained machine learning (ML) models. The results of the advanced analysis may include a list of identified items, categorized based on the item features extracted from the sensor data.

In some embodiments, the extracted item features, such as the identified quantity of items within the receptacle, and/or the results of the advanced analysis, such as the list of identified items, may then be compared with corresponding checkout data. In some embodiments, the checkout data may be provided by checkout devices at the enterprise site. By cross-referencing the items detected by the sensors with those scanned at the checkout devices, the system may effectively determine any discrepancies that may indicate fraudulent activities. For example, if items detected in the receptacle are not scanned at the checkout devices, or if there are inconsistencies in the size or quantity of items, the system may flag these transactions as potential fraud, and alert store employees for immediate action (e.g., manual verification). The disclosed methods, which involve utilizing acoustic wave sensors to detect items in a receptacle and comparing the findings with checkout records, not only streamline the self-checkout process but also improve the detection of fraudulent checkout activities.

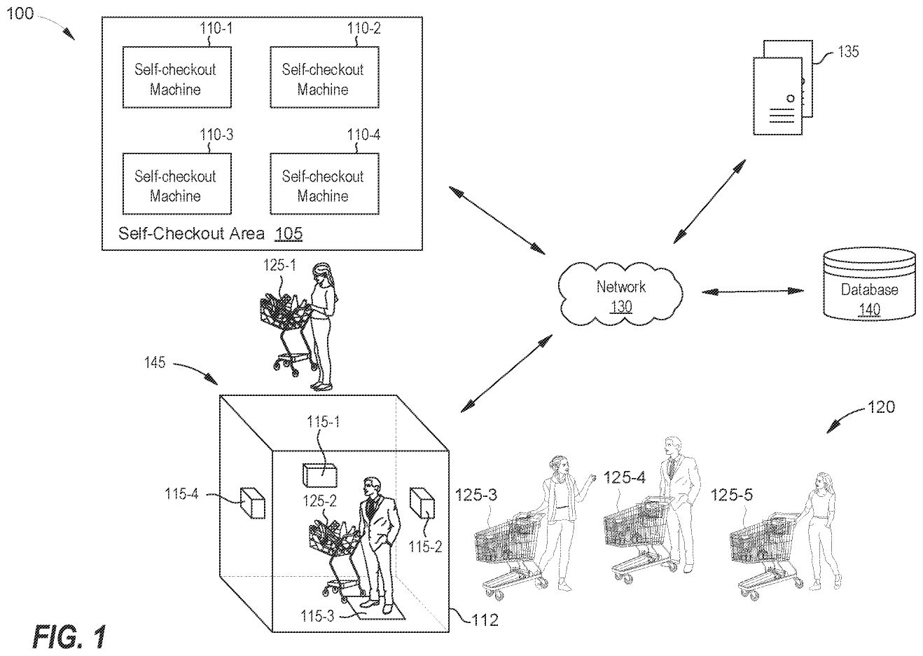

FIG. 1 depicts an example environment 100 for advanced fraud detection using acoustic technology, according to some embodiments of the present disclosure.

In some embodiments, the environment 100 for fraud detection may correspond to a retail establishment (e.g., a grocery store, a supermarket, an outlet mall, or a warehouse club). In the illustrated example, the environment 100 includes one or more self-checkout machines 110, one or more acoustic wave sensors 115, one or more servers 135, and a database 140. In some embodiments, one or more of the illustrated devices may be a physical device or system. In other embodiments, one or more of the illustrated devices may be implemented using virtual devices, and/or across a number of devices.

In the illustrated example, the self-checkout machines 110, the acoustic wave sensors 115, the servers 135, and the database 140 are remote from each other and communicate with each other via a network 130. Each of the devices may be implemented using discrete hardware systems. The network 130 may include or correspond to a wide area network (WAN), a local area network (LAN), the Internet, an intranet, or any combination of suitable communication mediums that may be available, and may include wired, wireless, or a combination of wired and wireless links. In some embodiments, each of the devices may be local to each other (e.g., within the same local network and/or the same hardware system), and communicate with one another using any appropriate local communication medium, such as a local area network (LAN) (including a wireless local area network (WLAN)), hardwire, wireless link, or intranet, etc.

In the illustrated example, multiple self-checkout machines 110 are located within the self-checkout area 105, where customers can scan, pay for, and/or bag their selected items independently. Each self-checkout machine 110 may comprise various components, including but not limited to a monitor, a barcode scanner, a scale, a payment terminal, and a printer. The components work collectively to ensure a smooth and efficient self-checkout experience for customers. As illustrated, adjacent to the self-checkout area 105 is a self-checkout queue 120, where customers line up with their receptacles 125 and wait for their turns for self-checkout. As discussed above, a “receptacle” may refer to any container (which may be open on one or more sides or may be entirely enclosed) that is capable of carrying or containing items, including, but not limited to, carts, baskets, and bags. Additionally, in embodiments where items are simply being carried in the user's hands or arms, the user herself may be considered as the receptacle.

In the illustrated example, a scanning area 145 is established within or near the self-checkout queue 120. In the illustrated example, the scanning area 145 includes a gate-like structure 112 around which one or more acoustic wave sensors 115 are installed. The acoustic wave sensors 115, as illustrated, are placed on different sides of the gate 112, such as the left (e.g., 115-4) and right (e.g., 115-2) sides, as well as the top (e.g., 115-1) and bottom (e.g., 115-3) sides. As a shopping cart 125-2 or another type of receptacles (e.g., a basket or a bag) moves through the gate 112, the sensors 115 scan the cart and its contents from multiple angles. The data collected by the various sensors, when aggregated together, may be used to generate a spatial model (e.g., 3D model) depicting the contents of the cart.

In some embodiments, instead of using a gate-like structure 112, the scanning area 145 may be an open space near or within the checkout queue 120. In such a configuration, the acoustic wave sensors 115 may be mounted on different surfaces, such as the ceiling, walls, and/or floors of the open area. As customers move their receptacles through this scanning area, the installed acoustic wave sensors 115 may activate to scan the receptacle's contents. This configuration may offer more flexibility in terms of space and can be easily integrated into existing layouts.

The illustrated example that depicts four acoustic wave sensors 115 being installed in the scanning area 145 is provided for conceptual clarity. In some embodiments, any number of acoustic wave sensors 115 may be installed at different locations within the scanning area to capture a comprehensive view of the receptacle's contents as it passes through.

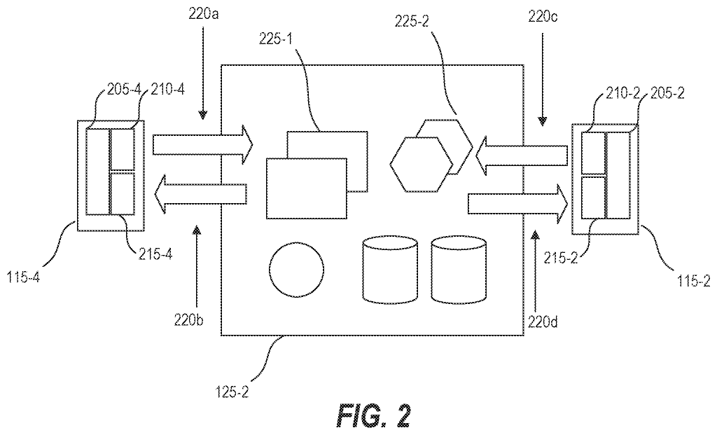

In the illustrated example, each acoustic wave sensor 115 emits acoustic waves towards the cart 125-2, and receives signals that are reflected back by the cart 125-2 or the items therein. The characteristics of these emitted and reflected waves, such as the time of flight (also referred to in some embodiments as time delay), amplitude, and frequency changes, may provide valuable information about the size, shape, or material composition of the items in the cart 125-2. The received signals may then be transmitted to the central severs 135 for further processing and analysis. In some embodiments, the acoustic wave sensors 115 may include a built-in processor (e.g., 205 of FIG. 2), which enables the sensors to preprocess the received signals before transmitting them to the central servers 135. The preprocessing may include filtering the signals to remove noise or irrelevant frequencies or performing initial data analysis (e.g., identifying time of flight, frequency changes, or other relevant parameters). The preprocessing by the acoustic wave sensors 115 facilitates a distributed processing architecture, where part of the data analysis is performed at the sensor level. Such configurations may effectively reduce the computational load of the central servers 135, and thus optimize the system's overall performance.

In the illustrated example, upon receiving the data (e.g., information about the emitted and reflected waves, and the processed parameters) transmitted by the acoustic wave sensors 115, the central servers 135 may interpret the data and perform various analyses. In some embodiments, the servers 135 may construct a visual representation of the cart's contents based on the sensor data. In some embodiments, the visual representation may include a three-dimensional (3D) model that depicts the physical dimensions, shapes, and arrangements of the items in the cart 125-2. Furthermore, in some embodiments, the servers 135 may extract features or characteristics of these items based on the generated model and the collected sensor data. These features may include the overall quantity of items in the cart 125-2, as well as details like the size, shape, or material of each item. In some embodiments, the item-specific features extracted from the senor data and/or the 3D model may be used for accurate object recognition using trained machine learning algorithms. The object recognition may allow the servers 135 to identify each individual item in the cart 125-2 and generate a corresponding list. In some embodiments, the object recognition process may involve matching the extracted features against a database of learned features from known items to ensure accurate identification/classification. In some embodiments, the generated item list (also referred to in some embodiments as the identification list) may identify individual items, such as a bottle of water or two packets of cereals. In some embodiments, the list may categorize the items into broader categories, such as “one bottled beverage” and “two snack foods.”

In some embodiments, following the feature extraction and/or object recognition, the servers 135 may undertake a comparison process to detect fraudulent activities. In some embodiments, the comparison may involve a simple quantity check, where the quantity of items identified from the 3D model is compared with the scanned quantity from corresponding checkout data (e.g., provided by a self-checkout machine at the enterprise site). In some embodiments, the comparison may be more complex, involving item-by-item or class-by-class verification. In such configurations, the servers 135 may compare the item list generated using object recognition technologies with the list of items actually scanned at the self-checkout machines (e.g., identified from checkout data). Based on the comparison, the servers 135 may identify discrepancies between the two lists, such as unscanned items or mismatches in quantities.

In some embodiments, upon detecting any discrepancies, the servers 135 may generate an alert. In some embodiments, the servers 135 may transmit the alert to store personnel or customers for further actions, such as rescanning items, manually verifying the contents of the shopping cart, or resetting a self-checkout machine when the discrepancies are caused by potential issues within the machine. In some embodiments, the discrepancies detected between the two lists, such as the list generated using object recognition technologies with the list of items actually scanned at the self-checkout machines, may not necessarily indicate fraudulent activities. Instead, these discrepancies may be caused by simple user errors. For example, a customer may accidentally scan one item multiple times on a self-checkout machine (e.g., 110-1), even though he or she only intends to purchase just one unit of the item. In such configurations, the servers 135 may instruct the self-checkout machine (e.g., 110-1) to display a message on its screen/interfaces, notifying the customer of the discrepancies and/or suggesting the customer to rescan the items in his or her receptacle. The discrepancy detection mechanism may therefore prevent inadvertent losses for the customers by ensuring they are only charged for the item they actually intend to buy.

In the illustrated example, the database 140 is configured to save data collected from various sources and/or data generated during various analyses. For example, the database may include sensor data collected by the acoustic wave sensors 115 (at the scanning area 145), the checkout data from the self-checkout machines 110, the generated visual representations (e.g., 3D models) and their corresponding features, and the comparison results (e.g., whether any discrepancies have been detected). The stored data may then be used to identify patterns or recurrent issues, therefore improving the overall performance of the fraud detection system.

FIG. 2 depicts travel paths for acoustic waves induced by acoustic wave sensors installed at different locations around a receptacle, according to some embodiments of the present disclosure.

The illustration provides a top-down view of the scanning area (e.g., 145 of FIG. 1). For example, the acoustic wave sensor 115-4 is depicted as installed on the left side of the scanning area, and the acoustic wave sensor 115-2 is depicted as installed on the right side of the scanning area. The two acoustic wave sensors 115-2 and 115-4 may be either wall-mounted or attached to a gate-like structure (e.g., 112 of FIG. 1). As illustrated, each acoustic wave sensor (e.g., 115-4) comprises a transmitter (e.g., 210-4), a receiver (e.g., 215-4) and an integrated processor (e.g., 205-4).

As a shopping cart 125-2 or another type of receptacles (e.g., a basket or a bag) is moved through the scanning area (e.g., by a customer who is waiting in the self-checkout line), the transmitter 210-4 of the acoustic wave sensor 115-4 emits acoustic waves 220a towards the left side of the cart 125-2. The emitted waves 220a may hit the items 225-1 in the cart 125-2 and then be reflected back towards the sensor 115-4. The reflected waves 220b are then collected by the receiver 215-4 of the sensor 115-4. The reflected waves 220b, in combination with the emitted waves 220a, may provide valuable information about the left side of the cart's contents. For example, a time of flight may be calculated by measuring the duration between the time waves 220a were emitted and the time waves 220b were received. The time of flight data may then be used to determine the distance of items 225 with respect to the sensor 115-4. In some embodiments, such as when one or more items are stacked over each other within the cart, the depth information (e.g., distances between items and sensors) may enable the system to accurately confirm the spatial arrangement of the items in the cart. By understanding the positioning and layering of the items, the system may more accurately assess the cart's contents, such as the total number of items in the cart and their individual physical attributes (e.g., size or shape). In some embodiments, the strength (or amplitude) of the reflected waves 220b may provide information about the size, shape, and/or material of the items (e.g., 225-1) within the cart. In some embodiments, changes in the frequency of these waves (e.g., the reflected waves 220b and the emitted waves 220a) may be used to detect movements within the cart, such as shifting or falling items, which helps to evaluate the items within the cart more accurately.

As the shopping cart 125-2 passes through the scanning area, the acoustic wave sensor 115-2 on the right side (operating concurrently or sequentially with the left side sensor 115-4) collects data about the right side of the cart 125-2. The acoustic wave sensor 115-2 emits acoustic waves 220c (by a transmitter 210-2) towards the cart 125-2, and receives acoustic waves 220d (by a receiver 215-2) that are reflected back by the cart 125-2 or the items 225-2 thereof. The process at the right-side acoustic wave sensor 1115-2 is similar to that of the left-side acoustic wave sensor 115-4, with waves interacting with the cart's contents and returning back to the sensor.

In the illustration, the sensors 115-4 and 115-2 are equipped with built-in computation capacities through the integrated processors 205-4 and 205-2. Such configurations may enable the sensors 115-4 and 115-2 to perform preliminary analysis locally, such as processing the wave data (e.g., the emitted waves 220a and 220c and/or the reflected waves 220b and 220d) to identify the relevant parameters (e.g., time of flight, amplitude, frequency changes). In some embodiments, the data collected by the acoustic wave sensors 115-4 and 115-2 may be transmitted directly to a central server system (e.g., 135 of FIG. 1) for further processing and analysis.

The two acoustic wave sensors 115-4 and 115-2 depicted in the illustration are provided for conceptual clarity. As discussed above, in some embodiments, any number of sensors 115 may be installed in the scanning area to optimize the detection process. These sensors may be installed at various locations, such as at the bottom, top, left, or right sides, or at the corners of the scanning areas, to capture the contents of the cart 125-2 from different angles. Such sensor arrangement may enable more comprehensive scanning coverage, to ensure that every part of the cart 125-2 is adequately captured, especially for items that may be obscured or hidden under other items.

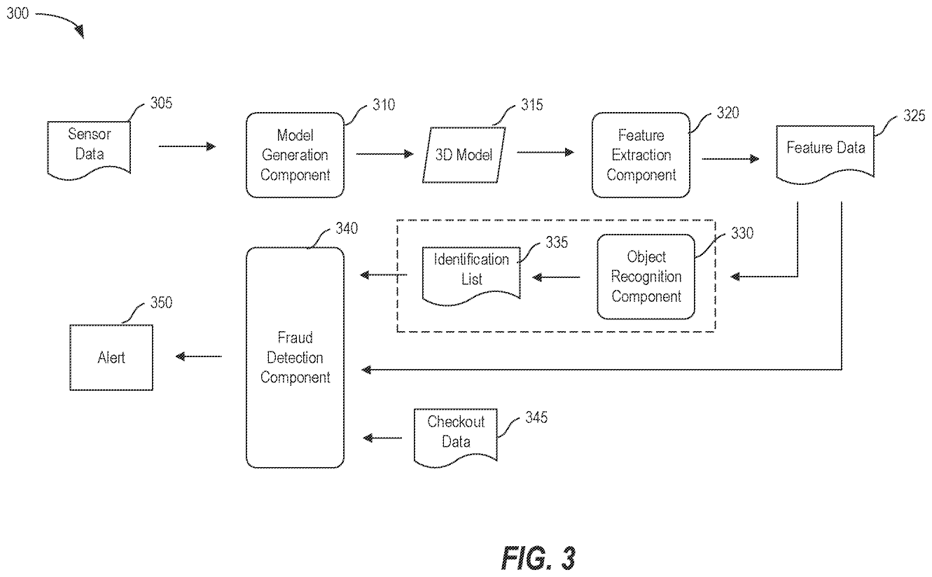

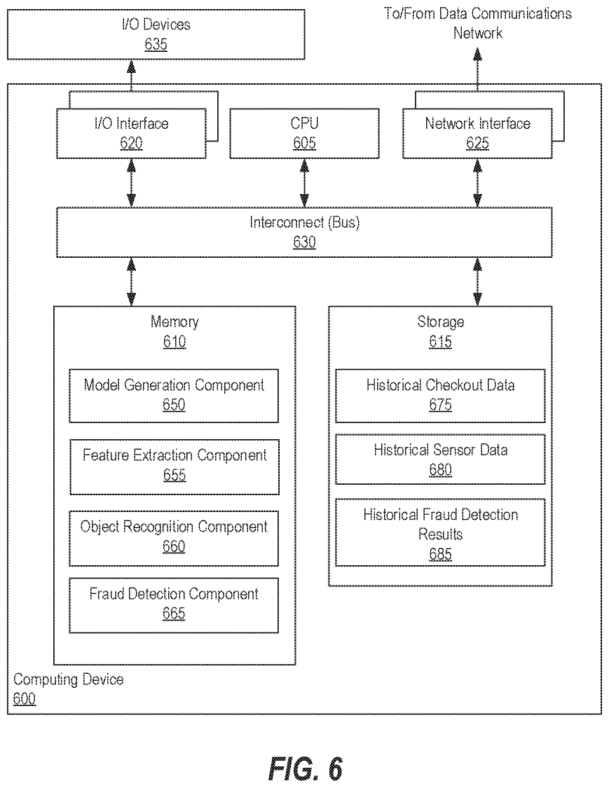

FIG. 3 depicts an example of workflow 300 for detecting checkout fraud using sensor data, according to some embodiments of the present disclosure. In some embodiments, the workflow 300 may be performed by one or more computing systems, such as the servers 135 as illustrated in FIG. 1, and/or the computing device 600 as illustrated in FIG. 6.

In the illustrated example, sensor data 305 is provided to the model generation component 310 for processing. In some embodiments, the sensor data 305 may refer to information gathered by the acoustic wave sensors (e.g., 115 of FIG. 1) as they emit waves towards and receive reflected signals from a receptacle and its contents. The sensor data may include raw wave data, such as details of the emitted and received waves, as well as data derived from these waves, such as the time of flight (or time delay), amplitude of the reflected signals, frequency changes of the waves upon their returns, and more.

In the illustrated example, upon receiving the sensor data 305, the model generation component 310 analyzes the data to generate a visual representation of the receptacle's contents. In some embodiments, the visual representation may include a 3D model 315. The 3D model may depict the contour of the items (e.g., 225 of FIG. 2) within the receptacle and their spatial arrangement. In some embodiments, the contour of these items (e.g., 225 of FIG. 2) may be determined based on varying characteristics of the acoustic waves, such as the strength (or amplitude) of the reflected signals or the frequency changes upon their returns, which provides valuable information about the shape and size of these items. In some embodiments, the spatial arrangement of these items within the receptacle may be determined based on the depth information calculated from the time of flight data, which measures the distance between the items and the sensors by tracking how long it takes for the emitted waves to be reflected back to the sensors.

In the illustrated example, the generated 3D model 315 is then provided to the feature extraction component 320. In some embodiments, the feature extraction component 320 may be configured to analyze the 3D model 315 and extract various features or characteristics 325 of the items in the receptacle. For example, in some embodiments, the feature extraction component 320 may evaluate the overall quantity of items in the receptacle by analyzing the number of distinct items in the 3D model 315. In some embodiments, based on the depth and contour information available in the 3D model 315, the feature extraction component 320 may identify the size and/or shape of each item. In some embodiments, different materials may affect the received acoustic signals in different ways, resulting in different acoustic signatures. For example, metal may reflect acoustic wave strongly, while plastic may absorb some of the wave energy, leading to different acoustic patterns or signatures. Such differences may be captured and incorporated into the 3D model. In some embodiments, the feature extraction component 320 may further infer the material properties of the items based on the acoustic signatures presented in the 3D model. As illustrated, the output of the feature extraction component 320 is feature data 325, which includes various features extracted from the 3D model 315, including but not limited to the overall quantity of items within the receptacle, the physical arrangement of these items (e.g., how items are stacked or placed in relation to each other), and the physical attributes of each time (e.g., size, shape, or material).

In the illustrated example, the feature data 325 extracted from the 3D model 315 may be directly transmitted to the fraud detection component 340 to detect the occurrence of fraudulent activities during the self-checkout process, and/or to the object recognition component 330 to further identify or classify each item in the receptacle before performing fraud detection. As illustrated, the checkout data 345 is also provided to the fraud detection component 340. In some embodiments, the checkout data 345 may be retrieved from a self-checkout machine (e.g., 110 of FIG. 1) at the enterprise location, and include transaction information confirming a list of items actually scanned by customers at self-checkout machines.

In embodiments where the feature data 325 is directly transmitted to the fraud detection component 340, the fraud detection component 340 may process the checkout data to identify the quantity of scanned items by customers, and then compare the scanned quantity with the quantity identified from the 3D model. Such comparison may enable the fraud detection component 340 to detect discrepancies between items that have been scanned at self-checkout and items that are physically present in the receptacle. Upon detecting a discrepancy (e.g., a mismatch in quantities), the fraud detection component 340 may generate an alert 350, and/or transmit the alert to store personnel. In some embodiments, the alert may notify the store personnel of the potential issues, such that some items in the receptacle have not been scanned, or that there may be an error in the self-checkout machine. In some embodiments, the alert may suggest immediate actions for store personnel, such as rescanning items that were mistakenly overlooked or left unscanned, manually verifying the contents of the receptacle, or resetting the self-checkout machine to address any technical issues that may have led to the error.

In embodiments where the feature data 325 is transmitted to the object recognition component 330, the object recognition component 330 may interpret the feature data 325 to identify each individual item (e.g., a bottle of water) or classify each item into a broader category (e.g., bottled beverage). The identification process may involve first training machine learning models (e.g., convolutional neural networks (CNNs)) to learn features from known items, and then comparing the extracted features, such as the size, shape, and/or material of each item in the receptacle, against the learned features. In some embodiments, the comparison may lead to the generation of a corresponding matching score for each item in the receptacle. In some embodiments, the matching score may represent how closely the features of the item in the receptacle match the features of a known item in a database. In some embodiments, the object recognition component 330 may label the items in the receptacle with the categories or item identifications with the highest matching scores. For example, if the feature data of an item in the receptacle closely matches the learned features of a bottle of water in the database, the object recognition component 330 may identify and label it as a bottle of water. Under such configurations, the object recognition component 330 may generate a list 335 (also referred to in some embodiments as an identification list) that identifies each item, such as a bottle of water or two packets of chips. If the feature data of an item in the receptacle closely matches the learned features of a broader category, like bottled beverage, the component 330 may categorize the item under the broader category. Under such configurations, the object recognition component 330 may generate a list 335 that details the quantities and categories of the items, such as “one bottled beverage,” “two snack foods,” or “four fresh produce items.”

In the illustrated example, the identification list 335 is then provided to the fraud detection component 340, which compares the list 335 with the checkout data 345 to detect any discrepancies, which may indicate the occurrence of fraudulent activities. In some embodiments, the fraud detection component 340 may process the checkout data to extract a transaction list. In some embodiments, the transaction list may refer to a record of items that have been scanned by a customer during his self-checkout process. In some embodiments, the transaction list may include detailed information such as the type, quantity, and/or price of each item that has been scanned.

Following the extraction of the transaction list, in some embodiments, the fraud detection component 340 may compare the transaction list with the identification list 335 (generated by the object recognition component 330). The comparison is designed to detect any discrepancies between items that were identified in the receptacle and items that were actually scanned by the customer. For example, if the identification list 335 indicates three snack foods, but the transaction list only includes two, this mismatch may indicate items that were overlooked or mistakenly scanned by the customers (e.g., mistakenly scanning one item multiple times), or potential errors in the self-checkout process. Upon identifying such discrepancies, the fraud detection component 340 may transmit an alert 350 to store personnel for further actions like manual verification or resetting the self-checkout machines. In some embodiments, the detected discrepancies may not necessarily indicate fraudulent activities. Instead, the discrepancies may be the result of simple user errors, such as forgetting to scan an item or scanning one item multiple times. In such configurations, the fraud detection component 340 may prompt a message on the self-checkout machine, notifying the customers of the discrepancies and suggesting a rescan. By doing so, the fraud detection component 340 may effectively prevent losses for both the customers and the business owners, to ensure that transactions are correctly billed and protect customers from unintentional overcharges and business owners from undercharging.

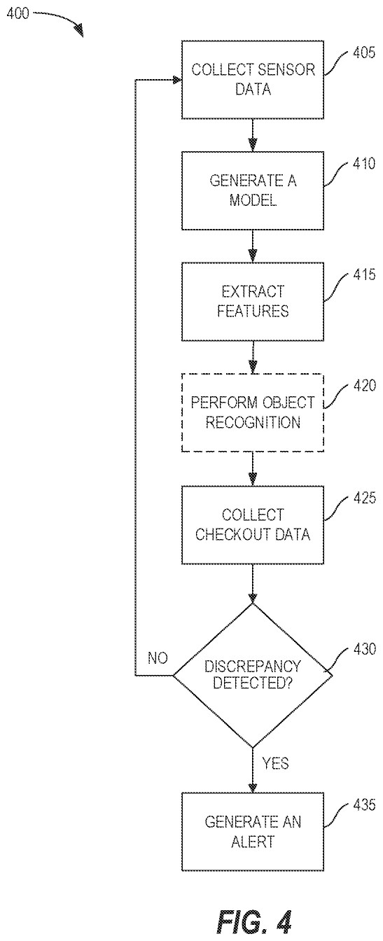

FIG. 4 depicts an example method 400 for generating alerts in response to potential checkout fraud based on collected sensor data and checkout data, according to some embodiments of the present disclosure. In some embodiments, the example method 400 may be performed by one or more computing systems, such as the servers 135 as illustrated in FIG. 1, and/or the computing device 600 as illustrated in FIG. 6.

The method 400 begins at block 405, where a computing system (e.g., central server 135 of FIG. 1) collects data from one or more acoustic wave sensors (e.g., 115 of FIG. 1). In some embodiments, the acoustic wave sensor may be installed at a scanning area (e.g., 145 of FIG. 1), which is established within or near the self-checkout queue at an enterprise site (e.g., a retail store). The setting of the scanning area ensures that the waiting customers and their receptacles (e.g., 125 of FIG. 1) (e.g., carts, baskets, and bags) pass through the scanning zone before reaching the self-checkout machines (e.g., 110 of FIG. 1). To achieve comprehensive coverage, in some embodiments, acoustic wave sensors (e.g., 115 of FIG. 1) may be positioned at various locations around the scanning zone, to capture a receptacle's contents from different perspectives. The sensor data is being collected as a customer pushes his receptacle through the scanning area. The sensors (e.g., 115 of FIG. 1) emit acoustic waves (e.g., 220a and 220c of FIG. 2) directed towards the receptacle, and capture the acoustic waves (e.g., 220b and 220d of FIG. 2) reflected back by the receptacle or its contents. The sensor data may include raw wave data, which includes both the emitted waves and the reflected waves. In some embodiments, such as when the sensors are equipped with built-in computing capacities, the sensors may preprocess the wave data before transmitting it to the computing system. For example, the sensors may filter the wave data to remove noise or irrelevant frequencies or analyze the wave data to identify relevant parameters, such as time of flight (e.g., the time the waves spent traveling to the receptacle and back), amplitude (or strength) of the received waves, and frequency changes. In some embodiments, these parameters may be used to generate a visual representation of the contents of the receptacle. In some embodiments, the computing system may collect sensor data from different acoustic wave sensors (e.g., those installed at different locations around the scanning area), and aggregate the data into a cohesive dataset.

At block 410, the computing system analyzes the received sensor data, and generates a visual representation (e.g., 3D model) of the receptacle's contents. In some embodiments, as discussed above, the sensor data may include the raw wave data and the processed parameters. In some embodiments, the visual representation may include a 3D model that depicts the contour and spatial arrangement of the items within the receptacle. In some embodiments, the generation of the model may be based on integrating sensor data collected from different acoustic wave sensors (e.g., those installed at different locations around the scanning area). For example, in some embodiments, the contours or shapes of items within the receptacle may be inferred by analyzing the amplitude and frequency data captured by these sensors. Each sensor, by capturing waves from its unique angle, contributes to a multi-dimensional view of items within the receptacle. In some embodiments, the spatial arrangement of items in the receptacle may be determined by calculating the distance of various points within the receptacle from the sensors. Such calculations may be achieved by analyzing the time of flight data, which measures the time taken for the acoustic waves to travel to the receptacle, be reflected by the items, and return to the sensors.

At block 415, the computing system analyzes the model to identify features or characteristics of the items within the receptacle. This process involves extracting either general or individual item features. For example, in some embodiments, the computing system may assess the total number of items in the receptacle. In some embodiments, the computing system may examine each item to determine its shape, size, or material composition.

At block 420, the computing system utilizes the extracted feature data to identify each item within the receptacle. In some embodiments, the object recognition process may involve training ML models (e.g., CNNs) on a vast dataset of known items, where the models learn to recognize features of each known item. Once the model training is complete, the computing system may use the trained models to analyze the features extracted from the items in the receptacle. Each item in the receptacle may be compared against the learned features in the ML models. The system may evaluate how closely the features of an item in the receptacle match with those of know items in the dataset. In some embodiments, the comparison may result in a matching score for each item, indicating the likelihood of the item being a known/target product (e.g., a bottle of water) or belonging to a broader category (e.g., bottled beverage). In some embodiments, the computing system may label each item in the receptacle with the category or item identification that corresponds to the highest matching scores from the ML analysis. Following the object recognition, the system may then compile the information into an identification list, which details the quantity and/or categories of the items identified in the receptacle. For example, in some embodiments, the list may include item identifications and their respective quantities, such as two bottles of waters or two packets of chips. In some embodiments, the list may include general categories and their respective quantities, such as “one bottled beverage,” “two snack foods,” or “four fresh produce items.”

At block 425, the computing system analyzes the checkout data provided by the self-checkout system. In some embodiments, the checkout data may include a list of items (along with their respective quantities) that a customer has scanned during his self-checkout process.

At block 430, the computing system compares the items identified from the sensor data with the items identified from the checkout data. The comparison is designed to identify whether the quantity or type of items detected in the receptacle (by acoustic wave sensors) align with the items that the customer has scanned at the self-checkout machine. If the computing system identifies a discrepancy (e.g., an item present in the receptacle but not reflected in the checkout data), the method 400 proceeds to block 435, where the computing system generates an alert. In some embodiments, the alert may be transmitted to store personnel, informing them of the potential issues and/or requesting immediate actions like manual verification to resolve the discrepancy. In some embodiments, as discussed above, the discrepancies may be caused by user errors, such as forgetting to scan an item or scanning one item multiple times. In such configurations, upon detecting a discrepancy, the computing system may instruct to display a message on the self-checkout machine, notifying customers of the discrepancies and suggesting a rescan. If the comparison reveals no discrepancies, which indicates that the customer's checkout process was accurate and compliant, the method 400 returns to block 405, where the computing system resumes its operations of collecting sensor data for the next receptacle. The cyclical process ensures continuous monitoring and fraud detection for each transaction at the self-checkout stations.

In some embodiments, the object recognition depicted at block 420 may be optional. For example, the computing system may utilize the general item feature (e.g., the overall quantity of items in the receptacle) for fraud detection. Under such configurations, the method 500 proceeds directly to block 425, where the computing system analyzes the checkout data to determine the quantity of items actually scanned by customers at a self-checkout machine. Subsequent to the determination, the computing system compares the two quantities (e.g., the quantity determined from the checkout data and the quantity determined from the sensor data). If a discrepancy is detected—such as the quantity from sensor data is larger than the quantity from checkout data—it may indicate there are unscanned or improperly scanned items in the receptacle. The method 500 then proceeds to block 435, where the computing system generates an alert to store personnel for manual verification. If no discrepancy is revealed—such as the quantity from sensor data matches the quantity from checkout data—it may indicate that all items in the current receptacle have been properly scanned. The method 500 returns to block 405, where the computing system continues to collect sensor data for the next receptacle.

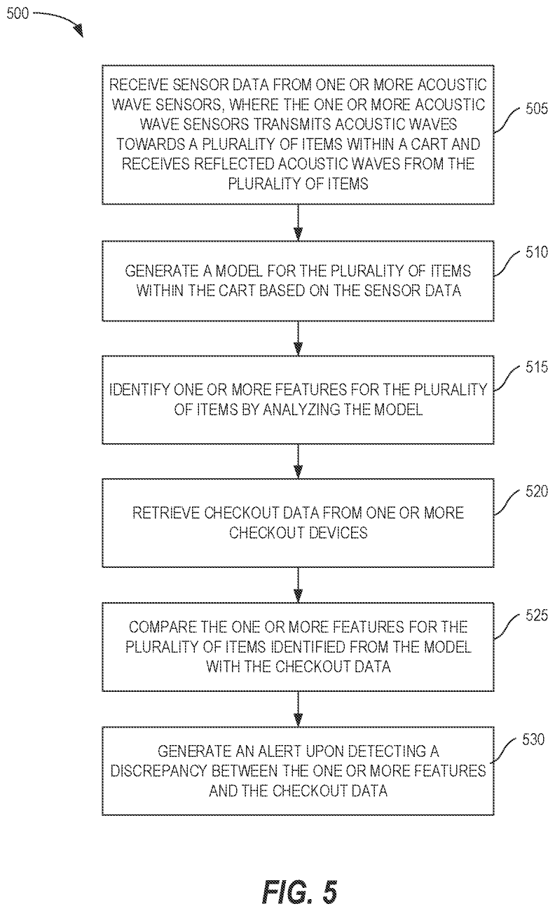

FIG. 5 is a flow diagram illustrating an example method 500 for fraud detection, according to some embodiments of the present disclosure.

At block 505, a computing system (e.g., central server 135 of FIG. 1) receives sensor data (e.g., 305 of FIG. 3) from one or more acoustic wave sensors (e.g., 115 of FIG. 1), where the one or more acoustic wave sensors transmit acoustic waves (e.g., 220a of FIG. 2) towards a set of items within a receptacle and receive reflected acoustic waves (e.g., 220b of FIG. 2) from the set of items.

At block 510, the computing system generates a model (e.g., 315 of FIG. 3) for the set of items within the receptacle based on the sensor data (e.g., 305 of FIG. 3). In some embodiments, the model may comprise a three-dimensional model of the set of items within the receptacle.

At block 515, the computing system identifies one or more features (e.g., 325 of FIG. 3) for the set of items by analyzing the model. In some embodiments, the one or more features may comprise at least one of a number of the set of items within the receptacle, a shape of an item of the set of items, a size of an item of the set of items, or a material composition of an item of the set of items.

At block 520, the computing system retrieves checkout data (e.g., 345 of FIG. 3) from one or more checkout devices (e.g., 110 of FIG. 1). In some embodiments, the checkout data may comprise a transaction list of items scanned by a user at the one or more checkout devices.

At block 525, the computing system compares the one or more features (e.g., 325 of FIG. 3) for the set of items identified from the model with the checkout data (e.g., 345 of FIG. 3).

At block 530, the computing system generates an alert (e.g., 350 of FIG. 3) upon detecting a discrepancy between the one or more features and the checkout data. In some embodiments, the discrepancy may comprise a variance in number, shape, or size of the set of items.

In some embodiments, the computing system may extract depth information for a respective item, of the set of items within the receptacle, based on a respective time of flight, where the respective time of flight is measured from a time when the acoustic waves were transmitted towards the respective item to a time when the corresponding reflected acoustic waves were received. In some embodiments, the depth information for the respective item may comprise a respective distance between the respective item and the one or more acoustic wave sensors.

In some embodiments, the computing system may generate an identification list of items from the model by comparing the identified one or more features to acoustic signatures that correspond to known items, and compare the identification list with the transaction list to detect the discrepancy.

FIG. 6 depicts an example computing device 600 configured to perform various aspects of the present disclosure, according to some embodiments of the present disclosure. Although depicted as a physical device, in some embodiments, the computing device 600 may be implemented using virtual device(s), and/or across a number of devices (e.g., in a cloud environment). The computing device 600 can be embodied as any computing device, such as the central server 135 as illustrated in FIG. 1, the model generation component 310, the feature extraction component 320, and the object recognition component 330, and the fraud detection component 340 as illustrated in FIG. 3.

As illustrated, the computing device 600 includes a CPU 605, memory 610, storage 615, one or more network interfaces 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally considered to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated embodiment, the memory 610 includes a model generation component 650, a feature extraction component 655, an object recognition component 660, and a fraud detection component 665. Although depicted as a discrete component for conceptual clarity, in some embodiments, the operations of the depicted component (and others not illustrated) may be combined or distributed across any number of components. Further, although depicted as software residing in memory 610, in some embodiments, the operations of the depicted components (and others not illustrated) may be implemented using hardware, software, or a combination of hardware and software.

In the illustrated embodiment, the model generation component 650 (which may correspond to the model generation component 310 of FIG. 3) receives sensor data from one or more acoustic wave sensors (e.g., sensors 115 installed at a scanning area 145 as illustrated in FIG. 1), and processes the data to construct a model (e.g., a 3D model) that depicts the contents of a receptacle (e.g., the cart 125-2 that passes through the scanning area 145 as illustrated in FIG. 1). In some embodiments, the sensor data (e.g., 305 of FIG. 3) may include information about the emitted and received acoustic waves. In some embodiments, such as when the sensors have built-in computation capabilities, the sensor data may include wave data, along with parameters identified from the wave data like time of flight, amplitude, and frequency changes. In some embodiments, the model (e.g., 315 of FIG. 3) generated by the model generation component 650 may depict the contour of items and their spatial arrangement within the receptacle. In some embodiments, the model may be generated by analyzing the sensor data in various ways. For example, in some embodiments, by analyzing the time of flight data, the model generation component 650 may determine the distance or position of each item within the receptacle. In some embodiments, by examining the frequency changes and/or amplitude of the reflected waves, the component 650 may infer the shape, size or material properties of the items.

In the illustrated embodiment, the feature extraction component 655 (which may correspond to the feature extraction component 320 of FIG. 3) is configured to analyze the model (e.g., 315 of FIG. 3) and/or the sensor data (e.g., 305 of FIG. 3) to extract features or characteristics (e.g., 325 of FIG. 3) related to the items in the receptacle. For example, in some embodiments, the feature extraction component 655 may identify the dimension or shape of each item and/or infer the material of each item based on the sensor data. In some embodiments, the feature extraction component 655 may assess the overall quantity of items within the receptacle. By analyzing the depth information and/or spatial relationships between items as depicted in the model, the component 655 may detect if items are stacked or hidden, and therefore ensure every item within the receptacle is properly identified and accounted for. In some embodiments, the extracted features (e.g., 325 of FIG. 3) may then be provided to the fraud detection component 665 and/or object recognition component 660 for further processing and analysis.

In the illustrated embodiment, the object recognition component 660 (which may correspond to the object recognition component 330 of FIG. 3) is designed to identify each item or categorize each item into a broader class based on the extracted features. In some embodiments, the object recognition component 660 may train ML models (e.g., CNNs) to learn features from known items. During the training phase, the models recognize and interpret the characteristics (e.g., shape, size, material) of different known items. Once the training is complete, the object recognition component 660 may then compare the extracted features from the items in the receptacle with the learned features. The comparison may result in the computation of matching scores, which quantify the similarity between items in the receptacle and the known items. The higher the score, the higher likelihood that the item matches the known characteristics. Based on the score, the object recognition component 660 may label each item with an item identification or a broader category that correspond to the highest matching score. In some embodiments, the output of the object recognition component 660 may include an identification list, which details each item or each category, along with each respective quantity, as identified in the receptacle.

In the illustrated embodiment, the fraud detection component 665 (which may correspond to the fraud detection component 340 of FIG. 3) is configured to analyze the checkout data (provided by the self-checkout system at the enterprise site), and compare the checkout data with the extracted features (e.g., quantity or size of the items) or the identification list generated by the object recognition component 660. In some embodiments, the checkout data may include a transaction list, detailing items actually scanned by customers at self-checkout machines. The comparison performed by the fraud detection component 665 aims to detect discrepancies between items that were identified in the receptacle by the acoustic wave sensors and items that were actually scanned by customers. For example, in some embodiments, the features identified from sensor data, such as the quantity or size of the items, may be compared with the checkout data. In some embodiments, such as when an identification list is generated by the object recognition component 660, the fraud detection component 665 may perform item-by-item or class-by-class verification by comparing the identification list against the transaction list from the checkout data. When the comparison reveals discrepancies, such as inconsistencies in quantity or size, or a mismatch between the identification list and transaction list, it may indicate potential issues. These may include items that were overlooked or mistakenly scanned by customers (e.g., mistakenly scanning one item multiple times), or potential errors in the self-checkout system. Upon detection of such discrepancies, the fraud detection component 665 may generate alerts for store personnel, informing them of the potential issues and requesting actions like manual verification.

In the illustrated example, the storage 615 may include historical checkout data 675, historical sensor data 680, and historical fraud detection results 685. In some embodiments, the historical checkout data 675 may include records of the transactions that have occurred at the self-checkout machines (e.g., 110 of FIG. 1). In some embodiments, the historical sensor data 675 may include raw wave data, such as the emitted and received acoustic waves, as well as processed data, such as time of flight, amplitude of reflected waves, and frequency changes. In some embodiments, the historical fraud detection results 680 may include logs of the discrepancies and potential fraudulent activities detected by the fraud detection component 665. In some embodiments, each of the historical fraud detection records 680 may detail the nature of the discrepancy, the items involved, the time of occurrence, and any actions taken in response. In some embodiments, the historical checkout data 675, the historical sensor data 680, and their corresponding historical fraud detection results 680 may be analyzed to understand the common patterns in checkout discrepancies, and/or refine the fraud detection system for better performance. In some embodiments, the aforementioned data may be saved in a remote database (e.g., 140 of FIG. 1) that connects to the computing device 600 via a network (e.g., 130 of FIG. 1).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., fraud detection application) or related data available in the cloud. For example, the fraud detection application may perform data processing and object recognition through a cloud computing infrastructure, and store the relevant results in a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving sensor data from one or more acoustic wave sensors, wherein the one or more acoustic wave sensors transmit acoustic waves towards a set of items within a receptacle and receive reflected acoustic waves from the set of items;
generating a model for the set of items within the receptacle based on the sensor data;
identifying one or more features for the set of items by analyzing the model;
retrieving checkout data from one or more checkout devices;
comparing the one or more features for the set of items identified from the model with the checkout data; and
generating an alert upon detecting a discrepancy between the one or more features and the checkout data.

2. The method of claim 1, wherein the one or more features comprise at least one of (i) a number of the set of items within the receptacle; (ii) a shape of an item of the set of items; (iii) a size of an item of the set of items; or (iv) a material composition of an item of the set of items.

3. The method of claim 1, wherein the discrepancy comprises a variance in number, shape, or size of the set of items.

4. The method of claim 1, further comprising extracting depth information for a respective item, of the set of items within the receptacle, based on a respective time of flight, wherein the respective time of flight is measured from a time when the acoustic waves were transmitted towards the respective item to a time when the corresponding reflected acoustic waves were received.

5. The method of claim 4, wherein the depth information for the respective item comprises a respective distance between the respective item and the one or more acoustic wave sensors.

6. The method of claim 1, wherein the model comprises a three-dimensional model of the set of items within the receptacle.

7. The method of claim 1, wherein the checkout data comprises a transaction list of items scanned by a user at the one or more checkout devices.

8. The method of claim 7, further comprising:
generating an identification list of items from the model by comparing the identified one or more features to acoustic signatures that correspond to known items; and
comparing the identification list with the transaction list to detect the discrepancy.

9. A system, comprising:
one or more processors;
one or more memories storing a program, which, when executed on any combination of the one or more processors, performs operations, the operations comprising:
receiving sensor data from one or more acoustic wave sensors, wherein the one or more acoustic wave sensors transmit acoustic waves towards a set of items within a receptacle and receive reflected acoustic waves from the set of items;
generating a model for the set of items within the receptacle based on the sensor data;
identifying one or more features for the set of items within the receptacle by analyzing the model;
retrieving checkout data from one or more checkout devices;
comparing the one or more features for the set of items identified from the model with the checkout data; and
generating an alert upon detecting a discrepancy between the one or more features and the checkout data.

10. The system of claim 9, wherein the one or more features comprise at least one of (i) a number of the set of items within the receptacle; (ii) a shape of an item of the set of items; (iii) a size of an item of the set of items; or (iv) a material composition of an item of the set of items.

11. The system of claim 9, wherein the program, which, when executed on any combination of the one or more processors, performs the operations further comprising extracting depth information for a respective item, of the set of items within the receptacle, based on a respective time of flight, wherein the respective time of flight is measured from a time when the acoustic waves were transmitted towards the respective item to a time when the corresponding reflected acoustic waves were received.

12. The system of claim 11, wherein the depth information for the respective item comprises a respective distance between the respective item and the one or more acoustic wave sensors.

13. The system of claim 9, wherein the model comprises a three-dimensional model of the set of items within the receptacle.

14. The system of claim 9, wherein the checkout data comprises a transaction list of items scanned by a user at the one or more checkout devices.

15. The system of claim 14, wherein the program, which, when executed on any combination of the one or more processors, performs operations, the operations further comprising:
generating an identification list of items from the model by comparing the identified one or more features to acoustic signatures that correspond to known items; and
comparing the identification list with the transaction list to detect the discrepancy.

16. One or more non-transitory computer-readable media containing, in any combination, computer program code that, when executed by operation of a computer system, performs operations comprising:
receiving sensor data from one or more acoustic wave sensors, wherein the one or more acoustic wave sensors transmit acoustic waves towards a set of items within a receptacle and receive reflected acoustic waves from the set of items;
generating a model for the set of items within the receptacle based on the sensor data;
identifying one or more features for the set of items by analyzing the model;
retrieving checkout data from one or more checkout devices;
comparing the one or more features for the set of items identified from the model with the checkout data; and
generating an alert upon detecting a discrepancy between the one or more features and the checkout data.

17. The one or more non-transitory computer-readable media of claim 16, wherein the one or more features comprise at least one of (i) a number of the set of items within the receptacle; (ii) a shape of an item of the set of items; (iii) a size of an item of the set of items; or (iv) a material composition of an item of the set of items.

18. The one or more non-transitory computer-readable media of claim 16, wherein the computer program code that, when executed by operation of a computer system, performs the operations further comprising extracting depth information for a respective item, of the set of items within the receptacle, based on a respective time of flight, wherein the respective time of flight is measured from a time when the acoustic waves were transmitted towards the respective item to a time when the corresponding reflected acoustic waves were received.

19. The one or more non-transitory computer-readable media of claim 18, wherein the depth information for the respective item comprises a respective distance between the respective item and the one or more acoustic wave sensors.

20. The one or more non-transitory computer-readable media of claim 16, wherein the model comprises a three-dimensional model of the set of items within the receptacle.
